(19) United States
(12) Patent Application Publication
(10) Pub. No.: US 2025/0384302 A1
(43) Pub. Date: Dec. 18, 2025

(54) GRADIENT BOOSTING REINFORCEMENT LEARNING

(71) Applicant: NVIDIA Corporation, Santa Clara, CA (US)

(72) Inventors: Benjamin Fuhrer, Tel Aviv (IL); Chen Tessler, Zichron Yaakov (IL); Gal Dalal, Shimshit (IL)

(21) Appl. No.: 19/090,214

(22) Filed: Mar. 25, 2025

Related U.S. Application Data
(60) Provisional application No. 63/660,958, filed on Jun. 17, 2024.

(51) Int. Cl. G06N 5/01

(52) U.S. Cl. CPC G06N 5/01

(57) ABSTRACT

Reinforcement learning, which is a machine learning technique where a model learns to make decisions that maximize a reward, has shown great promise in various domains that involve sequential decision making, including for many real-world tasks, such as inventory management, traffic signal optimization, network optimization, resource allocation, and robotics. However, current neural network (NN) based solutions for reinforcement learning struggle with interpretability, handling categorical data, and supporting light implementations suitable for low-compute devices. The present disclosure provides a gradient boosting trees (GBT) framework that is tailored for reinforcement learning, which may enable interpretability, may be well suited for real-world tasks with structured data, and may be capable of deployment on low-compute devices.

### CLAIM OF PRIORITY

This application claims the benefit of U.S. Provisional Application No. 63/660,958 (Attorney Docket No. NVIDP1407+/24-TV-0739US01) titled “GRADIENT BOOSTING REINFORCEMENT LEARNING,” filed Jun. 17, 2024, the entire contents of which is incorporated herein by reference.

### TECHNICAL FIELD

The present disclosure relates to reinforcement learning for real-world tasks.

### BACKGROUND

Reinforcement learning, which is a machine learning technique where a model learns to make decisions that maximize a reward, has shown great promise in various domains that involve sequential decision making. For example, many real-world tasks, such as inventory management, traffic signal optimization, network optimization, resource allocation, and robotics, which are represented with structured observations with categorical or mixed data types, can benefit from reinforcement learning as well as from deployment to edge devices at which the sequential decision making is actually used. Importantly, interpretability is crucial in these applications for regulatory reasons and for trust in the decision-making process.

However, current neural network (NN) based solutions struggle with interpretability, handling categorical data, and supporting light implementations suitable for low-compute devices. On the other hand, Gradient Boosting Trees (GBT) are a powerful ensemble method extensively used in supervised learning due to its simplicity, accuracy, interpretability, and natural handling of structured and categorical data. To date, GBT has seen limited application in reinforcement learning, which is primarily because traditional GBT libraries are designed for static datasets with predefined labels, contrasting with the dynamic nature of reinforcement learning. The distribution shift in both input (state) and output (reward) poses significant challenges for the direct application of GBT in reinforcement learning. Moreover, there is a notable lack of benchmarks or environments tailored for structured data, further hindering progress in this area.

There is a need for addressing these issues and/or other issues associated with the prior art. For example, there is a need for a GBT framework that is tailored for reinforcement learning, as this may provide interpretability, may be well suited for real-world tasks with structured data, and may be capable of deployment on low-compute devices.

### SUMMARY

In an embodiment, a method, computer readable medium, and system are disclosed for gradient boosting reinforcement learning, in which a model comprised of an ensemble of decision trees is trained over a plurality of iterations, including for each iteration: using the ensemble of decision trees to generate parameters for a policy; generating a trajectory of state and action pairs, by the policy parameterized with the parameters; and updating the ensemble of decision trees by: sampling a batch of the state and action pairs, computing gradients for the batch according to a reinforcement learning objective, constructing a new decision tree fitted to the gradients, and adding the new decision tree to the ensemble of decision trees to form an updated ensemble of decision trees.

In another embodiment, a method, computer readable medium, and system are disclosed for a gradient boosting algorithm, which includes growing an ensemble of decision trees over a plurality of iterations to continuously learn from an input stream of data; and outputting the ensemble of decision trees as a model configured to provide sequential decision making.

### BRIEF DESCRIPTION OF THE DRAWINGS

FIG. 1A illustrates a flowchart of a method for gradient boosting reinforcement learning, in accordance with an embodiment.

FIG. 1B illustrates a flowchart of a method of a gradient boosting algorithm, in accordance with an embodiment.

FIG. 2 illustrates a gradient boosting reinforcement learning framework, in accordance with an embodiment.

FIG. 3 illustrates a gradient boosting algorithm, in accordance with an embodiment.

FIG. 4 illustrates a flowchart of a method for using an ensemble of decision trees as a model that provides sequential decision making for an downstream application, in accordance with an embodiment.

FIG. 5A illustrates inference and/or training logic, according to at least one embodiment;

FIG. 5B illustrates inference and/or training logic, according to at least one embodiment;

FIG. 6 illustrates training and deployment of a neural network, according to at least one embodiment;

FIG. 7 illustrates an example data center system, according to at least one embodiment.

### DETAILED DESCRIPTION

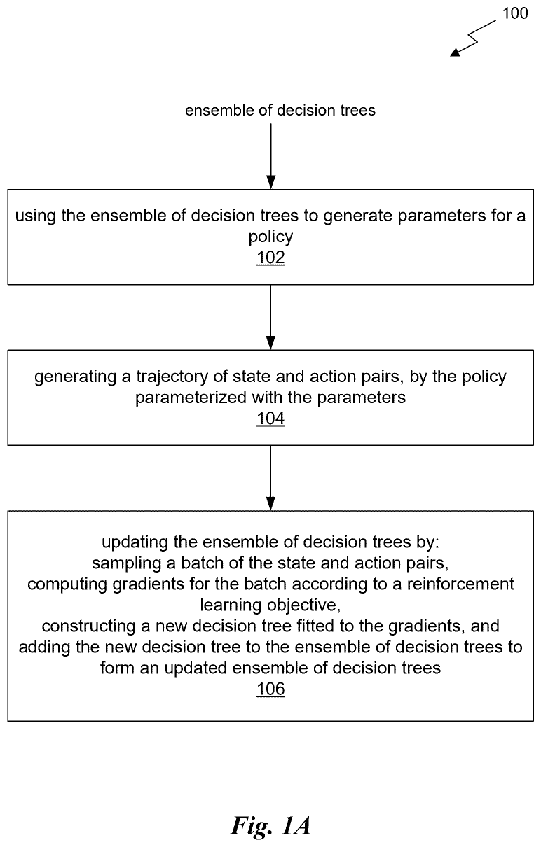

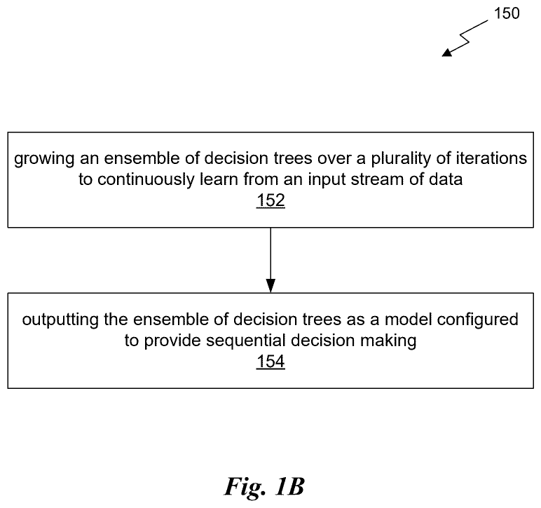

FIG. 1A illustrates a flowchart of a method 100 for gradient boosting reinforcement learning, in accordance with an embodiment. The method 100 may be performed by a device, which may be comprised of a processing unit, a program, custom circuitry, or a combination thereof, in an embodiment. In another embodiment, a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

The method 100 is performed in particular to train a model comprised of an ensemble of decision trees over a plurality of iterations. The ensemble of decision trees refers to one or more decision trees that, in combination, are configured to process an input to generate an output. A decision tree refers to a tree-like model (i.e. with a root, internal nodes, and leaves) of decisions and outcomes. In an embodiment, the decision tree may be a gradient boosting tree (GBT). As mentioned, the ensemble of decision trees represent a model, and accordingly once trained, the model can be deployed to process an input using the ensemble of decision trees in order to generate an output. As described herein, the model in particular can be (e.g. an agent) used for sequential decision making.

The operations 102-106 of the method 100 represents each iteration of the plurality of training iterations over which the model is trained. Thus, the method 100 may be repeated for every training iteration. In an embodiment, a number of the plurality of iterations may be predefined. In an embodiment, the number of the plurality of iterations may be two or more. In an embodiment, for an initial iteration of the plurality of iterations, the ensemble of decision trees may be comprised of an initialized (e.g. single) decision tree.

In operation 102, the ensemble of decision trees is used to generate parameters for a policy. The policy refers to a function that determines a trajectory (e.g. sequence) of state and action pairs. The parameters refer to values of the function. In an embodiment, the policy may be a Gaussian policy.

In an embodiment, the parameters for the policy may be generated by summing outputs of decision trees included in the ensemble of decision trees at the current iteration. Thus, at each iteration the parameters for the policy may be generated by summing outputs of decision trees included in the ensemble of decision trees at that iteration. In an embodiment, each decision tree in the ensemble of decision trees may include a plurality of leaves each constructed to predict the parameters for the policy. In an embodiment, the policy, parameterized with the parameters, may be created.

In operation 104, a trajectory of state and action pairs is generated, by the policy parameterized with the parameters. The trajectory refers to a sequence of state and action pairs over time. Each state and action pair refers to a state and an action resulting from the state. The trajectory may therefore include a state, the action corresponding to that state, then a next state resulting from the action, then a next action corresponding to that next state, and so on.

In operation 106, the ensemble of decision trees is updated by: sampling a batch of the state and action pairs, computing gradients for the batch according to a reinforcement learning objective, constructing a new decision tree fitted to the gradients, and adding the new decision tree to the ensemble of decision trees to form an updated ensemble of decision trees.

The batch of the state and action pairs refers to a subset of the state and action pairs included in the trajectory generated by the policy. In an embodiment, the state and action pairs may be sampled randomly for the batch (e.g. from the trajectory of state and action pairs). In an embodiment, a preconfigured number of state and action pairs may be sampled to form the batch.

The reinforcement learning objective by which the gradients for the batch are computed may be defined as a preconfigured reinforcement learning objective function. In an embodiment, the reinforcement learning objective may be defined by an actor critic algorithm. In an embodiment, the actor critic algorithm may utilize a shared approximation for an actor generating the actions and a critic generating rewards.

The new decision tree fitted to the computed gradients may then be constructed. In an embodiment, the new decision tree may be constructed to minimize an error of a prior tree added to the ensemble of decision trees. In an embodiment, the new decision tree may be constructed from multi-dimensional data that includes the gradients computed for the batch and a state for which each gradient was computed. In an embodiment, for each dimension of the multi-dimensional data up until a last dimension of the multi-dimensional data, the gradient of the dimension may be used for training policy parameters.

As mentioned, the new decision tree is then added to the ensemble of decision trees to form an updated ensemble of decision trees. In an embodiment, the updating of the ensemble of decision trees may be performed a predefined number of times (i.e. to add a new decision tree to the ensemble each time). In particular, for each iteration of the method 100, the ensemble of decision trees may be updated the predefined number of times. In an embodiment, the predefined number of times may be one. In another embodiment, the predefined number of times may be two or more.

Still yet, for updating the ensemble of decision trees, the method 100 may include using the ensemble of decision trees to generate a value function, and further computing rewards for the state and action pairs, using the value function. With respect to this embodiment, the state and action pairs may be stored with their rewards (e.g. in a buffer), such that for example sampling the batch of state and action pairs may include sampling the batch of state and action pairs with their corresponding rewards. The reinforcement learning objective may then be evaluated using the rewards when computing the gradients for the batch. Additionally, in an embodiment, tree-sharing may provide differentiated learning rates for the policy and the value function.

To this end, the method 100 may be performed to train a model comprised of an ensemble of decision trees including specifically to iteratively grow the ensemble of decision trees using reinforcement learning. In an embodiment, the method 100 may further include deploying the trained model. In an embodiment, the trained model may be deployed on a graphics processing unit (GPU).

In an embodiment, the trained model may be deployed to an edge device, such as a network interface card or a mobile device (e.g. mobile phone, tablet, handheld game console, etc.). For example, by using the decision tree as the backbone for reinforcement learning, as described in the embodiments above, the fast and efficient learning generally afforded by decision trees may be extended to reinforcement learning applications. As a result, the model, with a smaller memory footprint and requirement for fewer computational resources, may be particularly well-suited for edge deployment. Further, the above described adaptation of gradient boosting trees for the actor critic algorithm may allow for simultaneous optimization of distinct objectives, namely the learning of policy and value functions, which may benefit from GPU acceleration (i.e. parallel processing).

In an embodiment, the trained model may be deployed for use by a downstream application. In an embodiment, wherein the downstream application is configured to use the trained for model for sequential decision making. In an embodiment, the downstream application may stream input data, which may be structured and/or which may have categorical features, to the model for obtaining from the model in return an output stream of actions. In various examples, the downstream application may be a robotics application, an autonomous driving application, or a network congestion control application.

FIG. 1B illustrates a flowchart of a method 150 of a gradient boosting algorithm, in accordance with an embodiment. The method 150 may be performed by a device, which may be comprised of a processing unit, a program, custom circuitry, or a combination thereof, in an embodiment. In another embodiment, a system comprised of a non-transitory memory storage comprising instructions, and one or more processors in communication with the memory, may execute the instructions to perform the method 150. In another embodiment, a non-transitory computer-readable media may store computer instructions which when executed by one or more processors of a device cause the device to perform the method 150.

The method 150 may or may not be performed in the context of the method 100 of FIG. 1A, as described herein. Descriptions and definitions provided above may equally apply to the present method 100, in some embodiments. In operation 152, an ensemble of decision trees is grown over a plurality of iterations to continuously learn from an input stream of data. With respect to the present embodiment, the input stream of data refers to data that is streamed (e.g. continuously) as input.

In an embodiment, the ensemble of decision trees may be grown via the method 100 of FIG. 1A. In an embodiment, the ensemble of decision trees may be grown using a reinforcement learning objective. In an embodiment, the ensemble of decision trees are grown over one or more iterations including for each iteration of the one or more iterations: using a current ensemble of decision trees to generate parameters for a policy; generating a trajectory of state and action pairs, by the policy parameterized with the parameters; and updating the ensemble of decision trees by: sampling a batch of state and action pairs, computing gradients for the batch according to the reinforcement learning objective, constructing a new decision tree fitted to the gradients, and adding the new decision tree to the ensemble of decision trees to form an updated ensemble of decision trees.

In an embodiment, the reinforcement learning objective may be defined by an actor critic algorithm. In an embodiment, the actor critic algorithm may utilize a shared approximation for an actor generating actions and a critic generating rewards.

In operation 154, the ensemble of decision trees is output as a model configured to provide sequential decision making. In an embodiment, the sequential decision making involves streaming input data to the model for obtaining from the model in return an output stream of actions.

In an embodiment, the method 150 may further include deploying the model. In an embodiment, the model may be deployed for use by a downstream application that uses the model for the sequential decision making. In an embodiment, the downstream application may stream input data to the model for obtaining from the model in return an output stream of actions. The downstream may then cause each of the actions to be performed. In various exemplary embodiments, the downstream application may be a robotics application, an autonomous driving application, or a network congestion control application.

Further embodiments will now be provided in the description of the subsequent figures. It should be noted that the embodiments disclosed herein with reference to the method 100 of FIG. 1A and/or the method 150 of FIG. 1B may apply to and/or be used in combination with any of the embodiments of the remaining figures below.

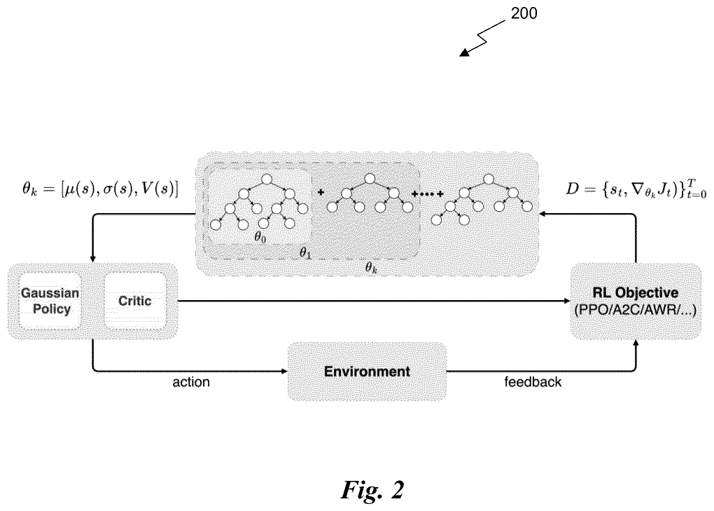

FIG. 2 illustrates a gradient boosting reinforcement learning framework 200, in accordance with an embodiment. In embodiments, the framework 200 may be implemented to carry out the method 100 of FIG. 1A and/or the method 150 of FIG. 1B. In an embodiment, the framework 200 may be implemented in hardware (e.g. on a GPU). In an embodiment, the framework 200 may be implemented in a combination of hardware and software.

The framework 200 relies on a unique combination of multiple paradigms in order to provide gradient boosting reinforcement learning. These paradigms are discussed below, as well as the manner in which they are utilized together to provide gradient boosting reinforcement learning.

### Markov Decision Process

A fully observable infinite-horizon Markov decision process (MDP) is characterized by the tuple (S, A, P, R). At each step, the agent observes a state s∈S and samples an action a∈A from its policy π(s, a). Performing the action causes the system to transition to a new state s′ based on the transition probabilities P(s′|s, a), and the agent receives a reward r˜R(s, a). The objective is to find an optimal policy π* that maximizes the expected discounted reward J(π)=

$$[ {\sum }_{t = 0}^{∞} {γ}^{t} {r}_{t} ] ,$$

with a discount factor γ∈[0, 1).

The action-value function

$${Q}_{π} ( s , a ) := {π}_{} [ {\sum }_{{t}^{′} = 0}^{∞} {γ}^{{t}^{′}} R ( {s}_{t + {t}^{′}} , {a}_{t + {t}^{′}} ) \vert {s}_{t} = s , {a}_{t} = a ]$$

estimates the expected returns of performing action a in state s and then acting according to π. Additionally, the value function

$${V}_{π} ( s ) := {π}_{} [ {\sum }_{{t}^{′} = 0}^{∞} {γ}^{{t}^{′}} R ( {s}_{t + {t}^{′}} , {a}_{t + {t}^{′}} ) \vert {s}_{t} = s ]$$

predicts the expected return starting from state s and acting according to π. Finally, the advantage function A_{π}(s, a)=Q_{π}(s, a)−V_{π}(s) indicates the expected relative benefit of performing action a over acting according to π.

### Actor-Critic Reinforcement Learning

Actor-critic (AC) methods can be used to solve the objective J(π). They learn both the policy and value. In the gradient boosting reinforcement learning framework 200, various possible AC algorithms may be used to support GBT-based function approximators, such as the three mentioned below.
(1) A2C is a synchronous, on-policy AC algorithm designed to improve learning stability. The critic learns a value function, V(s), used to estimate the advantage. This advantage is incorporated into the policy gradient updates, reducing variance and leading to smoother learning. The policy is updated using the following gradient: ∇_{θ}J(π_{θ})= [symbol] [∇_{θ}log π_{θ}(a|s)A(s, a)].
(2) PPO extends A2C by improving stability. This is achieved through constrained policy update steps using a clipped surrogate objective. This prevents drastic policy changes and leads to smoother learning. To achieve this, PPO solves the following objective:

$${∇}_{θ} J ( {π}_{θ} ) = [ {∇}_{θ} clip ( \frac{log {π}_{θ} ( a \vert S )}{log {{π}_{θ}}_{old} ( a \vert S )} , 1 - ϵ , 1 + ϵ ) A ( s , a ) ] .$$

Additionally, PPO enhances sample efficiency by performing multiple optimization steps on each collected rollout.
(3) AWR is an off-policy AC algorithm. Provided a dataset D, AWR updates both the policy and the value through supervised learning. This dataset can be pre-defined and fixed (offline), or continually updated using the agents experience (replay buffer). At each training iteration k, AWR solves the following two regression problems:

$${V}_{k} = \begin{matrix}arg min \\ V\end{matrix} {s , a ∼ D}_{} [ {‖ G ( s , a ) - V ( s ) ‖}_{2}^{2} ] , {π}_{k + 1} = \begin{matrix}arg max \\ π\end{matrix} {s , a ∼ D}_{} [ log π ( a \vert s ) exp ( \frac{1}{β} {A}_{k} ( s , a ) ) ] ,$$

where G(s, a) represents the monte-carlo estimate or TD(λ) of the expected return.

### Gradient Boosting Trees as Functional Gradient Descent

Gradient boosting trees (GBT) are a non-parametric machine learning technique that combines decision tree ensembles with functional gradient descent. GBT iteratively minimizes the expected loss L(F(x))= [symbol] _{x,y}[L(y, F(x))] over a dataset

$$D = {\{ ( {x}_{i} , {y}_{i} ) \}}_{i = 1}^{N} .$$

A GBT model, F_{K}, predicts outputs using K additive trees as follows:

$${F}_{K} ( {x}_{i} ) = {F}_{0} + {\sum }_{k = 1}^{K} ϵ {h}_{k} ( {x}_{i} ) ,$$

where ε is the learning rate, F₀ is the base learner, and each hₖ is an independent

regression tree partitioning the feature space.

In the context of functional gradient descent, the objective is to minimize the expected loss L(F(x))= [symbol] _{x,y}[L(y, F(x))] with respect to the functional F. Here, a functional F: H→ [symbol] maps a function space to real numbers. A GBT model can be viewed as a functional F that maps a linear combination of binary decision trees to outputs: F: lin(H)→ [symbol] ^{D}, where H is the decision tree function class.

In an embodiment, an initial model, F₀ is started with, and then trees are iteratively added to F to minimize the expected loss. Similar to parametric gradient descent, at each iteration k, the loss is minimized by taking a step in the direction of the functional gradient

$${g}_{k}^{i} := {∇}_{{F}_{k - 1}} L ( {y}_{i} , {F}_{k - 1} ( {x}_{i} ) ) .$$

However, there is a constraint to gradient directions within H. Thus, the gradient gₖ is projected into a decision tree by solving:

$${h}_{k} = \begin{matrix}arg min \\ h\end{matrix} {‖ = ϵ {g}_{k} - h ( x ) ‖}_{2}^{2} .$$

The present gradient boosting reinforcement learning framework 200 extends the framework of GBT to support AC algorithms in the task of reinforcement learning. The objective in reinforcement learning is to optimize the return J, the cumulative reward an agent receives. Unlike in supervised learning, the target predictions are unknown a priori. Reinforcement learning agents learn through trial and error. Good actions are reinforced by taking a step in the direction of the gradient ∇_{π}J. This formulation aligns perfectly with functional gradient ascent; thus, in gradient boosting reinforcement learning, the objective is optimized directly over the decision tree function class. This is achieved by iteratively growing the ensemble of trees {hᵢ}. The ensemble outputs θ, representing AC parameters such as the policy π and the value function. For example, θ=[μ(s), σ(s), V(s)] for a Gaussian policy. At each iteration, a new tree hₖ, constructed to minimize the distance to ∇_{θ}_{_{k−1}}J, is added to the ensemble. Here, the resulting method is an application of GBT as a functional gradient optimizer

$${θ}_{k} \approx {θ}_{0} + ϵ {\sum }_{m = 1}^{k - 1} {∇}_{{θ}_{m}} J .$$

However, reinforcement learning presents unique challenges for GBT. Reinforcement learning involves a nonstationary state distribution and inherent online learning, causing gradients to vary in magnitude and direction. Large gradients in unfavorable directions risk destabilizing training or leading to catastrophic forgetting. Moreover, feedback in reinforcement learning is provided through interactions with the environment and is not available a priori. This contrasts with supervised learning settings, where gradients decrease with boosting iterations, and targets are predefined. As a result, many of the key features that traditional GBT libraries rely on are not suitable.

To address these challenges, batch learning may be employed to update the ensemble. At each boosting iteration, a decision tree is fitted on a random batch sampled with replacement from an experience buffer. This approach helps handle non-stationary distributions and improve stability by focusing on different parts of the state space, allowing beneficial gradient directions to accumulate and minimizing the impact of detrimental ones. Additionally, the gradient boosting reinforcement learning framework 200 fits gradients directly to optimize objectives, whereas traditional GBT methods require targets and need workarounds to utilize gradients effectively.

A common theme in AC algorithms is to utilize a shared approximation for the actor and the critic. This approach is adopted in the gradient boosting reinforcement learning framework 200, constructing trees where each leaf provides two predictions. The gradient boosting reinforcement learning framework 200 predicts both the policy (distribution over actions) and the value estimate. The internal structure of the tree is shared, providing a single feature representation for both objectives and significantly reducing memory and computational bottlenecks. Accordingly, in the gradient boosting reinforcement learning framework 200 differentiated learning rates can be applied to the policy and value outputs during prediction, effectively optimizing distinct objectives within this shared structure.

As specifically illustrated in FIG. 2, the actor's policy and critic's value function are parameterized by θₖ. For example, θₖ=[μ(s), σ(s), V(s)] for a Gaussian policy. θₖ is calculated by summing all the outputs of trees in the ensemble. Starting from θ₀, at each training iteration, the gradient boosting reinforcement learning framework 200 collects a rollout and computes the gradient

$${∇}_{{θ}_{0}} J .$$

This gradient is then used to fit the next tree added to the ensemble, which is updated to θ₁. This process repeats with each iteration fitting a new tree, refining the parameterization, and expanding the ensemble towards

$${θ}_{k} \approx {θ}_{0} + ϵ {\sum }_{m = 1}^{k - 1} {∇}_{{θ}_{m}} J ,$$

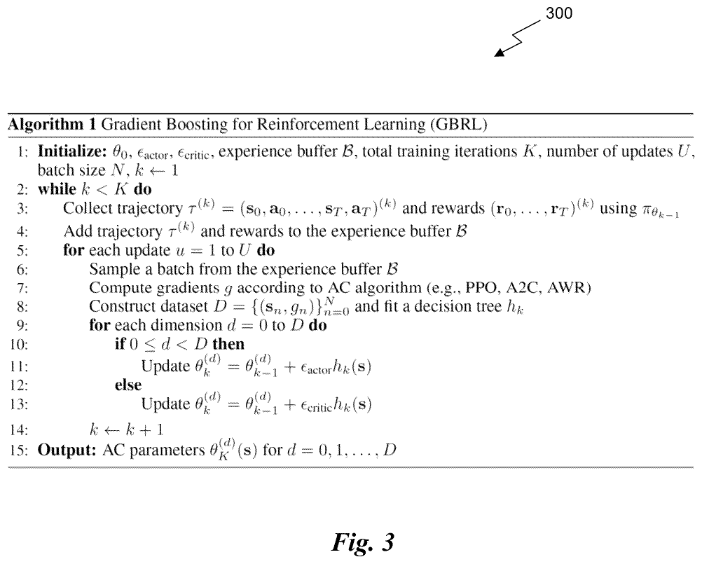

an approximated scaled sum of gradients with respect to past parametrizations. FIG. 3 illustrates an exemplary implementation of the gradient boosting algorithm described above, in accordance with an embodiment.

### Additional Embodiments of the Gradient Boosting Reinforcement Learning Framework 200

The gradient boosting reinforcement learning framework 200 is well-suited to work with structured data and/or categorical data.

The gradient boosting reinforcement learning framework 200 efficiently solves reinforcement learning tasks.

The gradient boosting reinforcement learning framework 200 may use a shared AC architecture which reduces GPU memory consumption and which increases computation speed without a negative performance impact on the resulting policy.

Historically, reinforcement learning practitioners have relied on tabular, linear, and neural network-based function approximators, without consideration of GBT. The gradient boosting reinforcement learning framework 200 effectively integrates GBT into reinforcement learning, and as a result can provide solutions that are more interpretable, well suited for real-world tasks with structured data, and/or capable of deployment on low-compute devices.

The gradient boosting reinforcement learning framework 200 efficiently adapts GBT for AC methods, which allows the simultaneous optimization of distinct objectives. This approach can be optimized for large-scale ensembles using GPU acceleration.

The gradient boosting reinforcement learning framework 200 integrates seamlessly with existing reinforcement learning libraries, promoting ease of use and adoption.

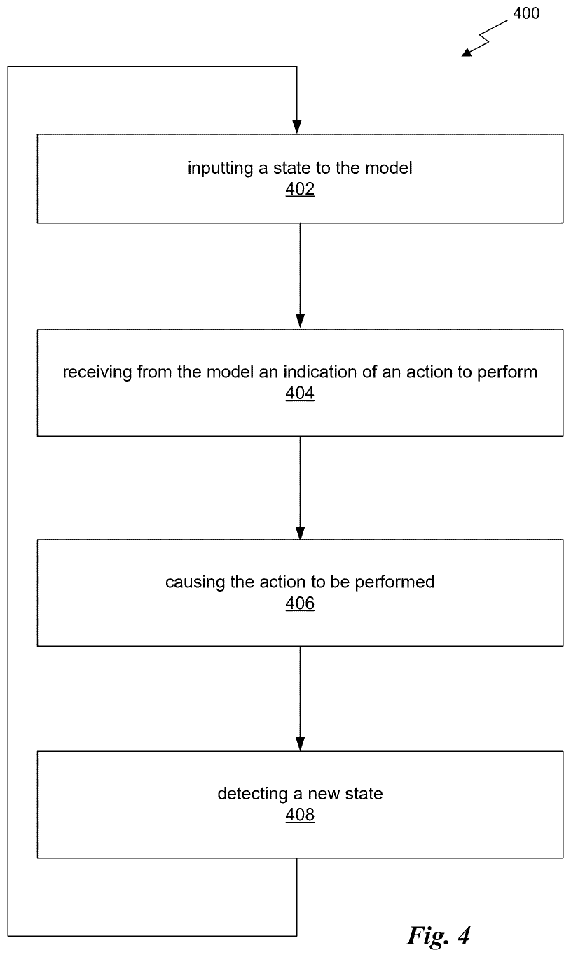

FIG. 4 illustrates a flowchart of a method 400 for using an ensemble of decision trees as a model that provides sequential decision making for an downstream application, in accordance with an embodiment. In embodiments, the downstream application may be a robotics application, an autonomous driving application, or a network congestion control application.

In operation 402, a state is input to the model. The state refers to the current state for which an action is to be performed. The state may be input by the downstream application. The state is input to the model to cause the model to generate an action to be performed.

For example, where the downstream application is an autonomous driving application, the state may be of an autonomous vehicle. As another example, where the downstream application is a robotics application, the state may be of a robot (e.g. an articulated robot). As another example, where the downstream application is a network congestion control application, the state may be of a network.

In operation 404, an indication of an action to perform is received from the model. As mentioned, the model is configured to process the input state to generate the action to perform. The action may be received by the downstream application.

For example, where the downstream application is the autonomous driving application, the action may be an action of the autonomous vehicle. As another example, where the downstream application is the robotics application, the action may be an action of the robot. As another example, where the downstream application is the network congestion control application, the action may be an action in the network.

In operation 406, the action is caused to be performed. For example, the downstream application may cause the action to be performed. In embodiments, the downstream application may cause an external system (e.g. the autonomous vehicle, the robot) to perform the action. In an embodiment, the downstream application (e.g. network congestion control application) may perform the action.

In operation 408, a new state is detected. The new state refers to the state observed as a result of the action being performed. The new state may be detected by the downstream application. The method 400 is then repeated for the new state. In this way, the method 400 may including the downstream application using the model for sequential decision-making purposes.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

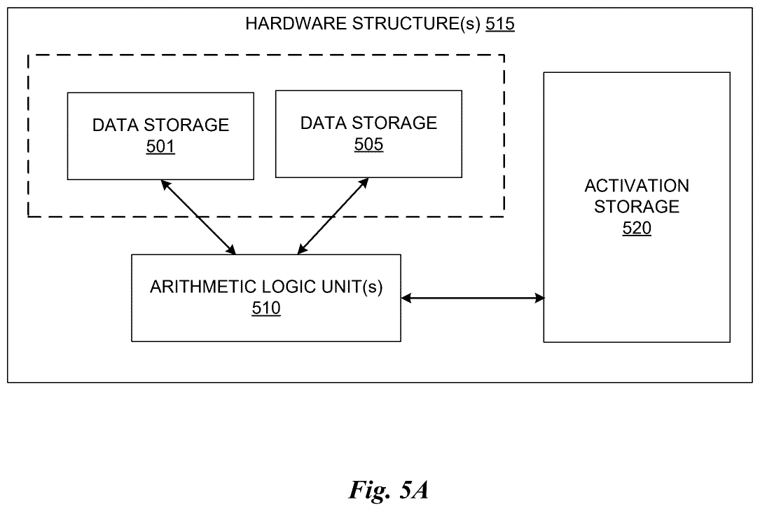

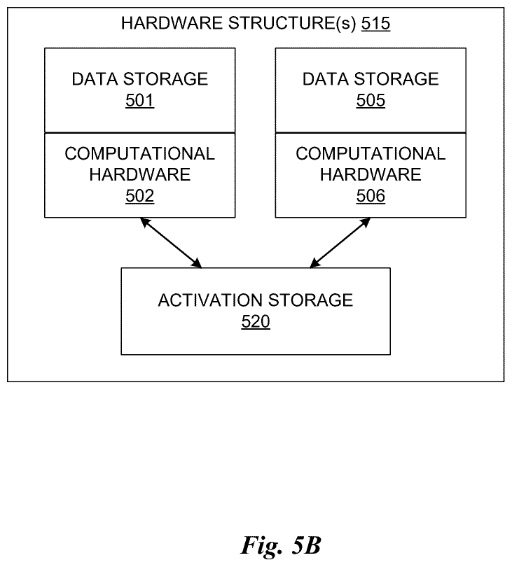

As noted above, a deep learning or neural learning system needs to be trained to generate inferences from input data. Details regarding inference and/or training logic 515 for a deep learning or neural learning system are provided below in conjunction with FIGS. 5A and/or 5B.

In at least one embodiment, inference and/or training logic 515 may include, without limitation, a data storage 501 to store forward and/or output weight and/or input/output data corresponding to neurons or layers of a neural network trained and/or used for inferencing in aspects of one or more embodiments. In at least one embodiment data storage 501 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 501 may be included with other on-chip or off-chip data storage, including a processor's L1, L2, or L3 cache or system memory.

In at least one embodiment, any portion of data storage 501 may be internal or external to one or more processors or other hardware logic devices or circuits. In at least one embodiment, data storage 501 may be cache memory, dynamic randomly addressable memory (“DRAM”), static randomly addressable memory (“SRAM”), non-volatile memory (e.g., Flash memory), or other storage. In at least one embodiment, choice of whether data storage 501 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 515 may include, without limitation, a data storage 505 to store backward and/or output weight and/or input/output data corresponding to neurons or layers of a neural network trained and/or used for inferencing in aspects of one or more embodiments. In at least one embodiment, data storage 505 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 505 may be included with other on-chip or off-chip data storage, including a processor's L1, L2, or L3 cache or system memory. In at least one embodiment, any portion of data storage 505 may be internal or external to on one or more processors or other hardware logic devices or circuits. In at least one embodiment, data storage 505 may be cache memory, DRAM, SRAM, non-volatile memory (e.g., Flash memory), or other storage. In at least one embodiment, choice of whether data storage 505 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 501 and data storage 505 may be separate storage structures. In at least one embodiment, data storage 501 and data storage 505 may be same storage structure. In at least one embodiment, data storage 501 and data storage 505 may be partially same storage structure and partially separate storage structures. In at least one embodiment, any portion of data storage 501 and data storage 505 may be included with other on-chip or off-chip data storage, including a processor's L1, L2, or L3 cache or system memory.

In at least one embodiment, inference and/or training logic 515 may include, without limitation, one or more arithmetic logic unit(s) (“ALU(s)”) 510 to perform logical and/or mathematical operations based, at least in part on, or indicated by, training and/or inference code, result of which may result in activations (e.g., output values from layers or neurons within a neural network) stored in an activation storage 520 that are functions of input/output and/or weight parameter data stored in data storage 501 and/or data storage 505. In at least one embodiment, activations stored in activation storage 520 are generated according to linear algebraic and or matrix-based mathematics performed by ALU(s) 510 in response to performing instructions or other code, wherein weight values stored in data storage 505 and/or data 501 are used as operands along with other values, such as bias values, gradient information, momentum values, or other parameters or hyperparameters, any or all of which may be stored in data storage 505 or data storage 501 or another storage on or off-chip. In at least one embodiment, ALU(s) 510 are included within one or more processors or other hardware logic devices or circuits, whereas in another embodiment, ALU(s) 510 may be external to a processor or other hardware logic device or circuit that uses them (e.g., a co-processor). In at least one embodiment, ALUs 510 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 501, data storage 505, and activation storage 520 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 520 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 520 may be cache memory, DRAM, SRAM, non-volatile memory (e.g., Flash memory), or other storage. In at least one embodiment, activation storage 520 may be completely or partially within or external to one or more processors or other logical circuits. In at least one embodiment, choice of whether activation storage 520 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 515 illustrated in FIG. 5A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5A may be used in conjunction with central processing unit (“CPU”) hardware, graphics processing unit (“GPU”) hardware or other hardware, such as field programmable gate arrays (“FPGAs”).

FIG. 5B illustrates inference and/or training logic 515, according to at least one embodiment. In at least one embodiment, inference and/or training logic 515 may include, without limitation, hardware logic in which computational resources are dedicated or otherwise exclusively used in conjunction with weight values or other information corresponding to one or more layers of neurons within a neural network. In at least one embodiment, inference and/or training logic 515 illustrated in FIG. 5B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5B may be used in conjunction with central processing unit (CPU) hardware, graphics processing unit (GPU) hardware or other hardware, such as field programmable gate arrays (FPGAs). In at least one embodiment, inference and/or training logic 515 includes, without limitation, data storage 501 and data storage 505, which may be used to store weight values and/or other information, including bias values, gradient information, momentum values, and/or other parameter or hyperparameter information. In at least one embodiment illustrated in FIG. 5B, each of data storage 501 and data storage 505 is associated with a dedicated computational resource, such as computational hardware 502 and computational hardware 506, respectively. In at least one embodiment, each of computational hardware 506 comprises one or more ALUs that perform mathematical functions, such as linear algebraic functions, only on information stored in data storage 501 and data storage 505, respectively, result of which is stored in activation storage 520.

In at least one embodiment, each of data storage 501 and 505 and corresponding computational hardware 502 and 506, respectively, correspond to different layers of a neural network, such that resulting activation from one “storage/computational pair 501/502” of data storage 501 and computational hardware 502 is provided as an input to next “storage/computational pair 505/506” of data storage 505 and computational hardware 506, in order to mirror conceptual organization of a neural network. In at least one embodiment, each of storage/computational pairs 501/502 and 505/506 may correspond to more than one neural network layer. In at least one embodiment, additional storage/computation pairs (not shown) subsequent to or in parallel with storage computation pairs 501/502 and 505/506 may be included in inference and/or training logic 515.

### Neural Network Training and Deployment

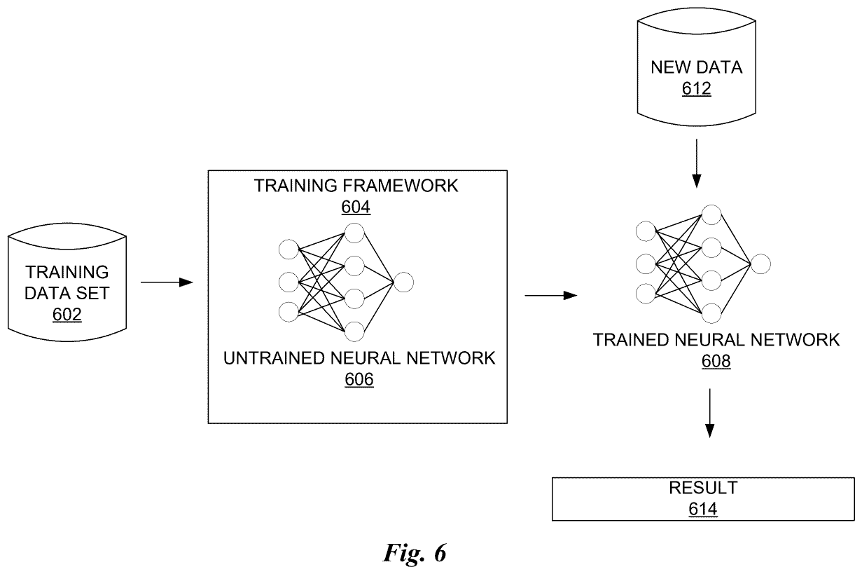

FIG. 6 illustrates another embodiment for training and deployment of a deep neural network. In at least one embodiment, untrained neural network 606 is trained using a training dataset 602. In at least one embodiment, training framework 604 is a PyTorch framework, whereas in other embodiments, training framework 604 is a Tensorflow, Boost, Caffe, Microsoft Cognitive Toolkit/CNTK, MXNet, Chainer, Keras, Deeplearning4j, or other training framework. In at least one embodiment training framework 604 trains an untrained neural network 606 and enables it to be trained using processing resources described herein to generate a trained neural network 608. In at least one embodiment, weights may be chosen randomly or by pre-training using a deep belief network. In at least one embodiment, training may be performed in either a supervised, partially supervised, or unsupervised manner.

In at least one embodiment, untrained neural network 606 is trained using supervised learning, wherein training dataset 602 includes an input paired with a desired output for an input, or where training dataset 602 includes input having known output and the output of the neural network is manually graded. In at least one embodiment, untrained neural network 606 is trained in a supervised manner processes inputs from training dataset 602 and compares resulting outputs against a set of expected or desired outputs. In at least one embodiment, errors are then propagated back through untrained neural network 606. In at least one embodiment, training framework 604 adjusts weights that control untrained neural network 606. In at least one embodiment, training framework 604 includes tools to monitor how well untrained neural network 606 is converging towards a model, such as trained neural network 608, suitable to generating correct answers, such as in result 614, based on known input data, such as new data 612. In at least one embodiment, training framework 604 trains untrained neural network 606 repeatedly while adjust weights to refine an output of untrained neural network 606 using a loss function and adjustment algorithm, such as stochastic gradient descent. In at least one embodiment, training framework 604 trains untrained neural network 606 until untrained neural network 606 achieves a desired accuracy. In at least one embodiment, trained neural network 608 can then be deployed to implement any number of machine learning operations.

In at least one embodiment, untrained neural network 606 is trained using unsupervised learning, wherein untrained neural network 606 attempts to train itself using unlabeled data. In at least one embodiment, unsupervised learning training dataset 602 will include input data without any associated output data or “ground truth” data. In at least one embodiment, untrained neural network 606 can learn groupings within training dataset 602 and can determine how individual inputs are related to untrained dataset 602. In at least one embodiment, unsupervised training can be used to generate a self-organizing map, which is a type of trained neural network 608 capable of performing operations useful in reducing dimensionality of new data 612. In at least one embodiment, unsupervised training can also be used to perform anomaly detection, which allows identification of data points in a new dataset 612 that deviate from normal patterns of new dataset 612.

In at least one embodiment, semi-supervised learning may be used, which is a technique in which in training dataset 602 includes a mix of labeled and unlabeled data. In at least one embodiment, training framework 604 may be used to perform incremental learning, such as through transferred learning techniques. In at least one embodiment, incremental learning enables trained neural network 608 to adapt to new data 612 without forgetting knowledge instilled within network during initial training.

### Data Center

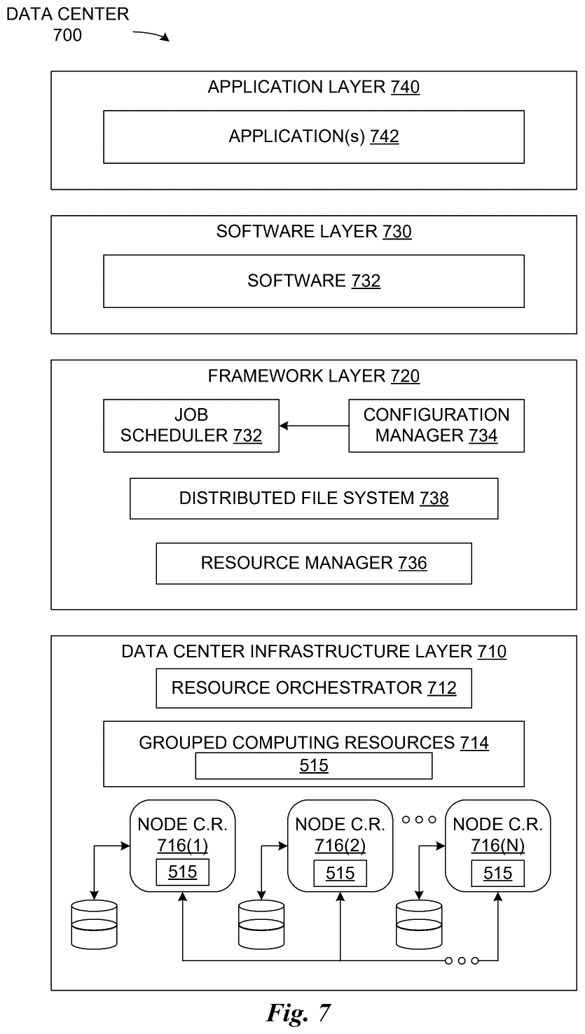

FIG. 7 illustrates an example data center 700, in which at least one embodiment may be used. In at least one embodiment, data center 700 includes a data center infrastructure layer 710, a framework layer 720, a software layer 730 and an application layer 740.

In at least one embodiment, as shown in FIG. 7, data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 716(1)-716(N) may be a server having one or more of above-mentioned computing resources.

In at least one embodiment, grouped computing resources 714 may include separate groupings of node C.R.s housed within one or more racks (not shown), or many racks housed in data centers at various geographical locations (also not shown). Separate groupings of node C.R.s within grouped computing resources 714 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 722 may configure or otherwise control one or more node C.R.s 716(1)-716(N) and/or grouped computing resources 714. In at least one embodiment, resource orchestrator 722 may include a software design infrastructure (“SDI”) management entity for data center 700. In at least one embodiment, resource orchestrator may include hardware, software or some combination thereof.

In at least one embodiment, as shown in FIG. 7, framework layer 720 includes a job scheduler 732, a configuration manager 734, a resource manager 736 and a distributed file system 738. In at least one embodiment, framework layer 720 may include a framework to support software 732 of software layer 730 and/or one or more application(s) 742 of application layer 740. In at least one embodiment, software 732 or application(s) 742 may respectively include web-based service software or applications, such as those provided by Amazon Web Services, Google Cloud and Microsoft Azure. In at least one embodiment, framework layer 720 may be, but is not limited to, a type of free and open-source software web application framework such as Apache Spark™ (hereinafter “Spark”) that may utilize distributed file system 738 for large-scale data processing (e.g., “big data”). In at least one embodiment, job scheduler 732 may include a Spark driver to facilitate scheduling of workloads supported by various layers of data center 700. In at least one embodiment, configuration manager 734 may be capable of configuring different layers such as software layer 730 and framework layer 720 including Spark and distributed file system 738 for supporting large-scale data processing. In at least one embodiment, resource manager 736 may be capable of managing clustered or grouped computing resources mapped to or allocated for support of distributed file system 738 and job scheduler 732. In at least one embodiment, clustered or grouped computing resources may include grouped computing resource 714 at data center infrastructure layer 710. In at least one embodiment, resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. one or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. In at least one embodiment, self-modifying actions may relieve a data center operator of data center 700 from making possibly bad configuration decisions and possibly avoiding underutilized and/or poor performing portions of a data center.

In at least one embodiment, data center 700 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 700. In at least one embodiment, trained machine learning models corresponding to one or more neural networks may be used to infer or predict information using resources described above with respect to data center 700 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 515 are used to perform inferencing and/or training operations associated with one or more embodiments. In at least one embodiment, inference and/or training logic 515 may be used in system FIG. 7 for inferencing or predicting operations based, at least in part, on weight parameters calculated using neural network training operations, neural network functions and/or architectures, or neural network use cases described herein.

As described herein, a method, computer readable medium, and system are disclosed to provide a machine learning model. In accordance with FIGS. 1-4B, embodiments may provide a machine learning model usable for performing inferencing operations and for providing inferenced data. The machine learning model may be stored (partially or wholly) in one or both of data storage 501 and 505 in inference and/or training logic 515 as depicted in FIGS. 5A and 5B. Training and deployment of the machine learning model may be performed as depicted in FIG. 6 and described herein. Distribution of the machine learning model may be performed using one or more servers in a data center 700 as depicted in FIG. 7 and described herein.

What is claimed is:

1. A method, comprising:
at a device, for each iteration of a plurality of iterations used to train a model comprised of an ensemble of decision trees:
using the ensemble of decision trees to generate parameters for a policy;
generating a trajectory of state and action pairs, by the policy parameterized with the parameters; and
updating the ensemble of decision trees by:
sampling a batch of the state and action pairs,
computing gradients for the batch according to a reinforcement learning objective,
constructing a new decision tree fitted to the gradients, and
adding the new decision tree to the ensemble of decision trees to form an updated ensemble of decision trees.

2. The method of claim 1, wherein for an initial iteration of the plurality of iterations, the ensemble of decision trees is comprised of an initialized decision tree.

3. The method of claim 1, wherein a number of the plurality of iterations is predefined.

4. The method of claim 3, wherein the number of the plurality of iterations is two or more.

5. The method of claim 1, wherein at each iteration the parameters for the policy are generated by summing outputs of decision trees included in the ensemble of decision trees.

6. The method of claim 1, wherein each decision tree in the ensemble of decision trees includes a plurality of leaves each constructed to predict the parameters for the policy.

7. The method of claim 1, wherein the policy is a Gaussian policy.

8. The method of claim 1, wherein the reinforcement learning objective is defined by an actor critic algorithm.

9. The method of claim 8, wherein the actor critic algorithm utilizes a shared approximation for an actor generating the actions and a critic generating rewards.

10. The method of claim 1, further comprising, at the device:
using the ensemble of decision trees to generate a value function;
computing rewards for the state and action pairs, using the value function.

11. The method of claim 10, wherein the state and action pairs are stored with their rewards.

12. The method of claim 11, wherein sampling the batch of state and action pairs includes sampling the batch of state and action pairs with their corresponding rewards.

13. The method of claim 10, wherein tree-sharing provides differentiated learning rates for the policy and the value function.

14. The method of claim 1, wherein the new decision tree is constructed to minimize an error of a prior tree added to the ensemble of decision trees.

15. The method of claim 1, wherein the new decision tree is constructed from multi-dimensional data that includes the gradients computed for the batch and a state for which each gradient was computed.

16. The method of claim 15, wherein for each dimension of the multi-dimensional data up until a last dimension of the multi-dimensional data, the gradient of the dimension is used for training policy parameters.

17. The method of claim 1, wherein the state and action pairs are randomly sampled.

18. The method of claim 1, wherein for each iteration of the plurality of iterations used to train the model comprised of the ensemble of decision trees, the updating of the ensemble of decision trees is performed a predefined number of times.

19. The method of claim 18, wherein the predefined number of times is one.

20. The method of claim 18, wherein the predefined number of times is two or more.

21. The method of claim 1, further comprising, at the device:
deploying the trained model.

22. The method of claim 21, wherein the trained model is deployed on a graphics processing unit (GPU).

23. The method of claim 21, wherein the trained model is deployed for use by a downstream application.

24. The method of claim 23, wherein the downstream application is configured to use the trained for model for sequential decision making.

25. The method of claim 23, wherein the downstream application streams input data to the model for obtaining from the model in return an output stream of actions.

26. The method of claim 25, wherein the input data is structured.

27. The method of claim 25, wherein the input data has categorical features.

28. The method of claim 23, wherein the downstream application is a robotics application.

29. The method of claim 23, wherein the downstream application is an autonomous driving application.

30. The method of claim 23, wherein the downstream application is a network congestion control application.

31. The method of claim 21, wherein the trained model is deployed to an edge device.

32. The method of claim 31, wherein the edge device is a network interface card.

33. The method of claim 31, wherein the edge device is a mobile phone.

34. A system, comprising:
a non-transitory memory storage comprising instructions; and
one or more processors in communication with the memory, wherein the one or more processors execute the instructions to train a model comprised of an ensemble of decision trees over a plurality of iterations including for each iteration:
using the ensemble of decision trees to generate parameters for a policy;
generating a trajectory of state and action pairs, by the policy parameterized with the parameters; and
updating the ensemble of decision trees by:
sampling a batch of the state and action pairs,
computing gradients for the batch according to a reinforcement learning objective,
constructing a new decision tree fitted to the gradients, and
adding the new decision tree to the ensemble of decision trees to form an updated ensemble of decision trees.

35. The system of claim 34, wherein at each iteration the parameters for the policy are generated by summing outputs of decision trees included in the ensemble of decision trees.

36. The system of claim 34, wherein the reinforcement learning objective is defined by an actor critic algorithm that utilizes a shared approximation for an actor generating the actions and a critic generating rewards.

37. The system of claim 34, wherein the new decision tree is constructed to minimize an error of a prior tree added to the ensemble of decision trees.

38. The system of claim 34, wherein the one or more processors further execute the instructions to:
deploy the trained model for use by a downstream application in sequential decision making.

39. The system of claim 38, wherein the downstream application is one of:
a robotics application,
an autonomous driving application, or
a network congestion control application.

40. A non-transitory computer-readable media storing computer instructions which when executed by one or more processors of a device cause the device to train a model comprised of an ensemble of decision trees over a plurality of iterations including for each iteration:
using the ensemble of decision trees to generate parameters for a policy;
generating a trajectory of state and action pairs, by the policy parameterized with the parameters; and
updating the ensemble of decision trees by:
sampling a batch of the state and action pairs,
computing gradients for the batch according to a reinforcement learning objective,
constructing a new decision tree fitted to the gradients, and
adding the new decision tree to the ensemble of decision trees to form an updated ensemble of decision trees.

41. The non-transitory computer-readable media of claim 40, wherein the reinforcement learning objective is defined by an actor critic algorithm that utilizes a shared approximation for an actor generating the actions and a critic generating rewards.

42. The non-transitory computer-readable media of claim 40, wherein the one or more processors further execute the instructions to:
deploy the trained model for use by a downstream application in sequential decision making;
wherein the downstream application is one of:
a robotics application,
an autonomous driving application, or
a network congestion control application.

43. A method, comprising:
at a device:
growing an ensemble of decision trees over a plurality of iterations to continuously learn from an input stream of data; and
outputting the ensemble of decision trees as a model configured to provide sequential decision making.

44. The method of claim 43, wherein the ensemble of decision trees are grown using a reinforcement learning objective.

45. The method of claim 44, wherein the ensemble of decision trees are grown over one or more iterations including for each iteration of the one or more iterations:
using a current ensemble of decision trees to generate parameters for a policy;
generating a trajectory of state and action pairs, by the policy parameterized with the parameters; and
updating the ensemble of decision trees by:
sampling a batch of state and action pairs,
computing gradients for the batch according to the reinforcement learning objective,
constructing a new decision tree fitted to the gradients, and
adding the new decision tree to the ensemble of decision trees to form an updated ensemble of decision trees.

46. The method of claim 44, wherein the reinforcement learning objective is defined by an actor critic algorithm.

47. The method of claim 46, wherein the actor critic algorithm utilizes a shared approximation for an actor generating actions and a critic generating rewards.

48. The method of claim 43, wherein the sequential decision making involves streaming input data to the model for obtaining from the model in return an output stream of actions.

49. The method of claim 43, further comprising, at the device:
deploying the model.

50. The method of claim 49, wherein the model is deployed for use by a downstream application that uses the model for the sequential decision making.

51. The method of claim 50, wherein the downstream application streams input data to the model for obtaining from the model in return an output stream of actions.

52. The method of claim 51, wherein the downstream application is one of:
a robotics application,
an autonomous driving application, or
a network congestion control application.
